(19) United States
(12) Patent Application Publication
(10) Pub. No.: US 2010/0175635 A1
(43) Pub. Date: Jul. 15, 2010

(54) PERCH ASSEMBLIES FOR BIRDS

(76) Inventor: Elia MARTINEZ, Avondale, AZ (US)

Correspondence Address: MICHAEL WINFIELD GOLTRY, 4000 N. CENTRAL AVENUE, SUITE 1220, PHOENIX, AZ, 85012, US

(21) Appl. No.: 12/558,739

(22) Filed: Sep. 14, 2009

Related U.S. Application Data
(60) Provisional application No. 61/205,313, filed on Jan. 15, 2009.

(51) Int. Cl. A01K 31/12; A01K 45/00

(52) U.S. Cl. 119/713

(57) ABSTRACT

A perch assembly for a bird includes a substantially cone-shaped body including an open bottom and opposed upper and lower surfaces that narrow from the open bottom to an opposed vertex, and a perch for a bird carried by the substantially cone-shaped body proximate to the vertex. An annular waste-collection trough is formed in and encircles the bottom of the substantially cone-shaped body. A handle is attached to the vertex of the substantially cone-shaped body and extends downwardly from the vertex with respect to the lower surface to a lower end located below and away from the bottom of the substantially cone-shaped body.

### CROSS REFERENCE TO RELATED APPLICATION

This application claims the benefit of U.S. Provisional Patent Application Ser. No. 61/205,313, filed Jan. 15, 2009.

### FIELD OF THE INVENTION

The present invention relates to perches for birds.

### BACKGROUND OF THE INVENTION

There are many different types of birds. They come in all sizes and colors. While groups or types of birds share common behavioral patterns, every individual bird comes with its own unique behavioral characteristics and temperament.

Getting the right bird starts with gathering information on the different types of birds. Some birds like handling more than others, and some birds are best to watch. Some birds talk, while others have a beautiful song. There are exotic pet birds that are treasured because of their color, while others are enjoyed because their colorful personalities.

Before acquiring a pet bird, it is important to learn as much as possible about the type of bird under consideration. Only with the right knowledge and understanding can one know what to expect from a particular bird and how best to care for the bird.

Pet bird care starts with a proper housing environment. Factors to consider in deciding how best to house a bird may include personal limitations coupled with what is needed to meet the specific needs of a particular bird. Suitable housing can take the form of a simple bird house or cage of a size suitable to permit the bird to move about comfortably. Some bird cages or houses are even formed with an associated play area outside of the bird cage or house, often utilizing a playpen or the like. A flight cage for regular exercise can also be used, as can an aviary.

Regardless of the type of enclosure used, all birds should be housed in an enclosure that is as roomy as possible, and this is especially important for birds that will spend most or all of their time in the enclosure. The enclosure should contain bowls for food, treats, and water. Small birds can use plastic bowls. Ceramic or stainless steel bowls generally are needed for medium and large parrots.

Incorporating environmental enrichment bird toys in an enclosure is a great way to combat boredom and provide exercise for a pet bird. Toys for birds are designed in many combinations of woods, leathers, ropes, chains, bells and even acrylics. Toys such as swings and ladders are designed for chewing and climbing, while stainless steel mirrors are for viewing and comfort.

A suitable bird enclosure should be fashioned with perches, which provide standing places for birds. Perch size and shape can vary depending on the bird, but should fit their feet. For instance, a 1-inch diameter perch is comfortable for most parrots, while a ½-inch perch normally suits smaller birds. Round and oval wooden perches are often used, and sometimes plastic perches are used for small birds. Variety in both size and shape is important to exercise the feet of birds. In fact, natural branches are great for providing this variety. Concrete perches make suitable perches for parrots to help them keep both nails and beak trim.

Some birds like handling and human interaction more than others. For such a bird, such as a parakeet or the like, it is important to let the bird out of its enclosure as much as possible and to interact with the bird. Doing this often creates strong bonds between the bird and the owner, which contributes not only to the enjoyment of the owner but also improves the quality of life for the bird. The problem with letting a bird out of its enclosure, however, is that it might bite or defecate and it can be difficult to hold the bird in a way that is comfortable for the bird, and also safe for the bird. Accordingly, what is needed are perches and perch assemblies specifically adapted for use outside of an enclosure, which are portable, provide safe and comfortable perching areas for birds, and provide protection for the bird handler.

### SUMMARY OF THE INVENTION

According to the principle of the invention, a perch assembly for a bird includes a substantially cone-shaped body including an open bottom and opposed upper and lower surfaces that narrow from the open bottom to an opposed vertex, and a perch for a bird carried by the substantially cone-shaped body, and the perch is formed proximate to the vertex. An annular waste-collection trough is formed in and encircles the bottom of the substantially cone-shaped body. A handle has an upper end and an opposed lower end. A first fastener assembly releasably secures the upper end of the handle to the vertex of the substantially cone-shaped body, and the first fastener assembly includes a first element thereof carried by the upper end of the handle and a first complementing element thereof carried by the vertex. The handle extends downwardly from the vertex with respect to the lower surface of the substantially cone-shaped body to the lower end of the handle, which is located below and away from the bottom of the substantially cone-shaped body. A base is attached to the lower end of the handle, and the base is positionable upon a support surface to support the perch assembly in a stable, upright position. A second fastener assembly releasably secures the lower end of the handle to the base, and the second fastener assembly includes a second element thereof carried by the lower end of the handle and a second complementing element thereof carried by the base. The first element of the first fastener assembly is a first threaded engagement element, and the first complementing element of the first fastener assembly is a first complementing threaded engagement element threadably engaging the first threaded engagement element. The second element of the second fastener assembly is a second threaded engagement element, and the second complementing element of the second fastener assembly is a second complementing threaded engagement element threadably engaging the second threaded engagement element. In a particular embodiment there is ladder that opposes the upper surface of the substantially cone-shaped body, and which extends between the trough and the perch.

According to the principle of the invention, a perch assembly for a bird includes a substantially cone-shaped body including an open bottom and opposed upper and lower surfaces that narrow from the open bottom to an opposed vertex, an elongate support including an upper end and an opposed lower end attached to the vertex of the substantially cone-shaped body, a perch for a bird formed in the upper end of the elongate support, and the elongate support extends upwardly from the vertex with respect to the upper surface to the upper end formed with the perch. An annular waste-collection trough is formed in and encircles the bottom of the substantially cone-shaped body. A handle has an upper end attached to the vertex of the substantially cone-shaped body and extends downwardly from the vertex with respect to the lower surface and the lower end of the elongate support to a lower end located below and away from the bottom of the substantially cone-shaped body. A base is attached to the lower end of the handle, and the base is positionable upon a support surface to support the perch assembly in a stable, upright position.

According to the principle of the invention, a perch assembly for a bird includes an elongate support including an upper end and an opposed lower end, a perch for a bird formed in the upper end of the elongate support, and a substantially cone-shaped body including an open bottom and opposed upper and lower surfaces that narrow from the open bottom to an opposed vertex. A first fastener assembly releasably secures the lower end of the elongate support to the vertex of the substantially cone-shaped body. The first fastener assembly includes a first element thereof carried by the lower end of the elongate body and a first complementing element thereof carried by the vertex. The elongate support extends upwardly from the vertex with respect to the upper surface to the upper end formed with the perch. An annular waste-collection trough is formed in and encircles the bottom of the substantially cone-shaped body. A handle has an upper end and an opposed lower end. A second fastener assembly releasably secures the upper end of the handle to the vertex of the substantially cone-shaped body. The second fastener assembly includes a second element thereof carried by the upper end of the handle and a second complementing element thereof carried by the vertex. The handle extends downwardly from the vertex with respect to the lower surface and the lower end of the elongate support to the lower end of the handle located below and away from the bottom of the substantially cone-shaped body. A base is attached to the lower end of the handle, and the base is positionable upon a support surface to support the perch assembly in a stable, upright position. A third fastener assembly releasably secures the lower end of the handle to the base. The third fastener assembly includes a third element thereof carried by the lower end of the handle and a third complementing element thereof carried by the base. The first element of the first fastener assembly is a first threaded engagement element, and the first complementing element of the first fastener assembly is a first complementing threaded engagement element threadably engaging the first threaded engagement element. The second element of the second fastener assembly is a second threaded engagement element, and the second complementing element of the second fastener assembly is a second complementing threaded engagement element threadably engaging the second threaded engagement element. The third element of the third fastener assembly is a third threaded engagement element, and the third complementing element of the third fastener assembly is a third complementing threaded engagement element threadably engaging the third threaded engagement element.

Further perch assemblies constructed and arranged in accordance with the principle of the invention include handled perches that may be taken up by hand and used to carry birds from place to place. In one embodiment the perch may be formed by an elongate rod or dowel or the like. In other embodiments, the perch is formed by a broad, rimmed, shallow bowl-like structure suitable for use in transporting birds having physical limitations or by breeders and veterinarians handling young hatchlings. These and other handled perch assemblies constructed and arranged in accordance with the principle of the invention have releasably attached handles allowing the perches to be separated from the handles for cleaning or replacement.

Consistent with the foregoing summary of preferred embodiments, and the ensuing detailed description, which are to be taken together, the invention also contemplates associated perch assembly embodiments.

### BRIEF DESCRIPTION OF THE DRAWINGS

Referring to the drawings:

FIG. 1 is a perspective view of a perch assembly for a bird, the perch assembly constructed and arranged in accordance with the principle of the invention and shown as it would appear with a bird perched on a perch of the perch assembly;

FIG. 2 is a top perspective view of the perch assembly of FIG. 1;

FIG. 3 a bottom perspective view of the perch assembly of FIG. 1;

FIG. 4 is a side elevation view of the perch assembly of FIG. 1;

FIG. 5 is a sectional view taken along line 5-5 of FIG. 2;

FIG. 6 is an exploded side elevation view of the perch assembly of FIG. 1;

FIG. 6A is a side elevation view of the perch assembly of FIG. 1 shown as it would appear taken up by hand;

FIG. 7 is a perspective view of an alternate embodiment of a perch assembly for a bird, the perch assembly constructed and arranged in accordance with the principle of the invention;

FIG. 8 is a top plan view of the perch assembly of FIG. 7;

FIG. 9 is a perspective view of another alternate embodiment of a perch assembly for a bird, the perch assembly constructed and arranged in accordance with the principle of the invention and shown as it would appear with a bird perched on perch of the perch assembly;

FIG. 10 is a front elevation view of the perch assembly of FIG. 9;

FIG. 11 is a sectional view taken along line 11-11 of FIG. 10;

FIG. 12 is a perspective view of yet another alternate embodiment of a perch assembly for a bird, the perch assembly constructed and arranged in accordance with the principle of the invention;

FIG. 13 is a bottom perspective view of the perch assembly of FIG. 12;

FIG. 14 is a perspective view of the perch assembly of FIG. 12 shown as it would appear in use;

FIG. 15 is a sectional view of the perch assembly taken along line 15-15 of FIG. 14 illustrating a hand concurrently received by a receiving area and a strap formed in the perch assembly;

FIG. 16 is a vertical sectional view of yet still a further alternate embodiment of a perch assembly for a bird, the perch assembly constructed and arranged in accordance with the invention;

FIG. 17 is a perspective view of still another alternate embodiment of a perch assembly for a bird, the perch assembly constructed and arranged in accordance with the principle of the invention and shown as it would appear with a bird perched on a perch of the perch assembly;

FIG. 18 is a perspective view of the perch assembly of FIG. 17;

FIG. 19 is a sectional view taken along line 19-19 of FIG. 18;

FIG. 20 is an exploded side elevation view of the perch assembly of FIG. 17;

FIG. 21 is a perspective view of yet another alternate embodiment of a perch assembly for a bird, the perch assembly constructed and arranged in accordance with the principle of the invention and shown as it would appear with a bird perched on a perch of the perch assembly;

FIG. 22 is a top perspective view of the perch assembly of FIG. 21; and

FIG. 23 is a bottom perspective view of the perch assembly of FIG. 21.

### DETAILED DESCRIPTION

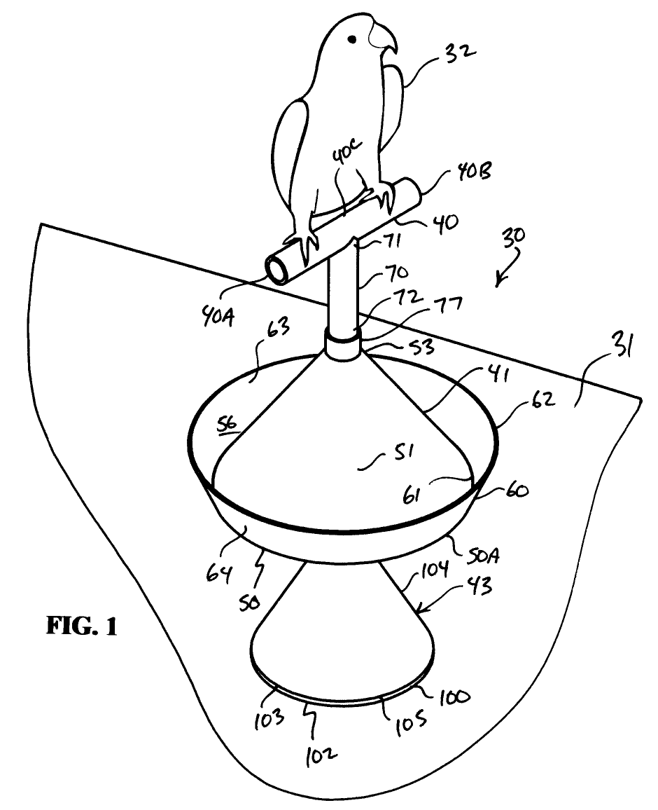

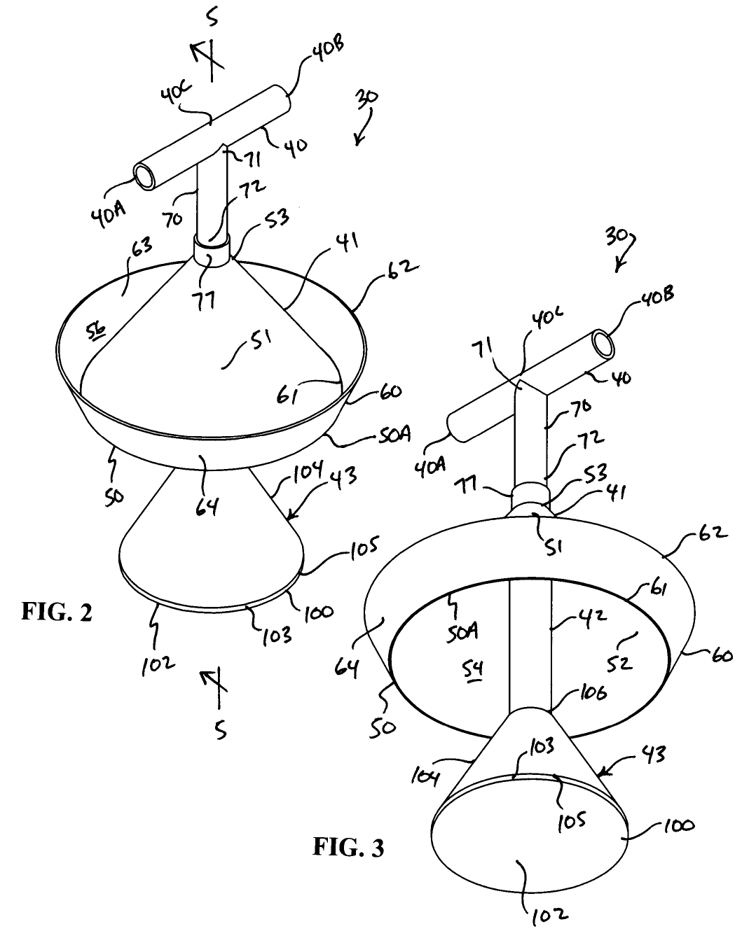

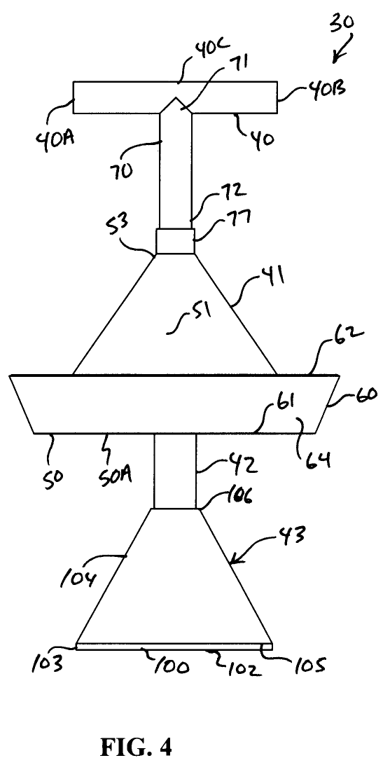

Turning now to the drawings, in which like reference characters indicate corresponding elements throughout the several views, attention is first directed to FIGS. 1-5 illustrating a perch assembly 30 for a bird, and which is constructed and arranged in accordance with the principle of the invention. Perch assembly 30 includes a perch 40, a shell or body 41, a handle 42 (shown in FIGS. 3-5), and a base 43. Perch assembly 30 is for a bird, and in FIG. 1 perch assembly 30 is shown as it would appear positioned upon a support surface denoted at 31 in an upright, stable position, with a bird 32 perched on perch 40. Support surface 31 can be the top of a table, desk, counter, etc. Perch assembly 30 is self-contained, may be used in a bird enclosure, such as a bird cage, bird house, or aviary, and may be easily taken up by hand and held while a bird, such as bird 32, is perched on perch 40 allowing a user to carry such a bird about while perched on perch 40 of perch assembly 30. Like all perch assemblies presented in this specification, perch assembly 30 is preferably constructed of plastic, but may alternatively be formed of aluminum, carbon fiber, or like of similar substantially rigid material or combination of materials, and the various parts of perch assembly 30 may be integrally formed, such as with conventional molding or machining techniques, or form as an assembly of two or more parts attached with welding, fasteners, or joinery.

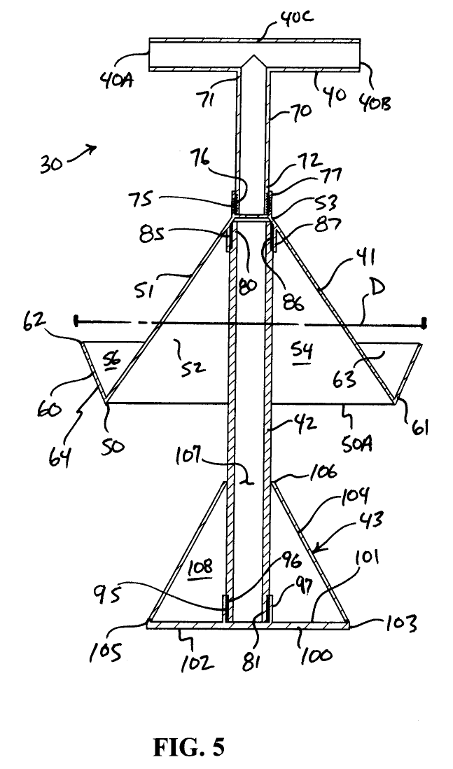

Referencing FIG. 5, body 41 is substantially cone-shaped and is a continuous sidewall that has a bottom 50 and an opposed top or vertex 53, and opposed upper and lower surfaces 51 and 52 formed therebetween. Bottom 50 is open, broad, and generally circular in shape, and is formed by a continuous edge 50A formed in bottom 50 that leads into interior 54 of body 41 bound by lower surface 52 between vertex 53 and bottom 50. Upper and lower surfaces 51 and 52 of the continuous sidewall forming body 41 narrow from bottom 50 at continuous edge 50A to vertex 53, which is spaced from and opposes bottom 50.

An annular waste-collection trough 56 is formed in body 41 as shown in FIGS. 1-5. Trough 56 is formed in bottom 50 of body 41, and encircles bottom 50 of body 41. Trough 56 is formed by an attached upstanding sidewall 60, which cooperates with upper surface 51 of body 41 proximate to bottom 50 to form trough 56. Referencing FIG. 5, sidewall 60 has a continuous lower edge 61 affixed to continuous edge 50A formed in bottom 50 of body 41, and extends substantially upright with respect to continuous edge 50A of bottom 50 of body 41 to an opposed continuous upper edge 62. Sidewall 60 has an inner surface 63 facing upper surface 51 of body 41, and an opposed outer surface 64 facing away from upper surface 51 of body 41. Sidewall 60, including inner and outer surfaces 63 and 64, is pitched somewhat outwardly with respect to upper surface 51 of body 41 and bottom 50, and trough 56 is formed by and between inner surface 63 of sidewall 60 and the opposing portions of upper surface 51 of body 41, in which the bottom of trough 56 is formed at the attachment point between continuous edge 50A of body 41 and lower edge 61 of sidewall 60. Trough 56 has an outer diameter denoted at D extending to and defined by continuous upper edge 62 of continuous sidewall 60. Continuous sidewall 60 may be considered part of body 41, or otherwise an extension of body 41.

Perch 40 is an elongate, cylindrical body having opposed ends 40A and 40B and a midsection 40C therebetween as illustrated in FIGS. 1-5. In this example, the cylindrical body forming perch 40 is hollow, but may be solid if desired. Perch 40 is sized and shaped to fit the feet of a perching bird, such as bird 32 in FIG. 1. Referencing FIG. 5, attached to and depending from midsection 40C of perch 40 is an elongate support 70. Like perch 40, elongate support 70 is an elongate, cylindrical body, which, in this example, is hollow but may be solid if desired. Elongate support 70 has an upper end 71 affixed to midsection 40C of perch 40, and an opposed lower end 72 attached to vertex 53 of body 41. Upper end 71 of elongate support 70 is preferably integrally formed with respect to midsection 40C of perch 40, but may, if desired, by affixed by welding techniques, adhesive, joinery, or other fastening assembly formed therebetween, such as a threaded fastener assembly, a snap fastener assembly, a detent fastening assembly, or the like. Perch 40 is thus formed in upper end 71 of elongate support 70, and elongate support 70 extends upwardly from vertex 53 of body 41 with respect to upper surface 51 from lower end 72 at vertex 53 to upper end 71 of elongate support 70 formed with perch 40.

A fastener assembly is formed between lower end 72 of elongate support 70 and vertex 53 of body 41, which releasably secures lower end 72 of elongate support 70 to vertex 53 of body 41 thereby releasably securing perch 40 with respect to vertex 53 of body 41. The fastener assembly is formed by a threaded element 75 formed in lower end 72 of elongate support 70, and a complementing threaded element 76 formed in vertex 53.

In the present example, threaded element 75 formed in lower end 72 of elongate support 70 consists of external threads or threading formed in lower end 72 of elongate support 70, and complementing threaded element 76 formed in vertex 53 consists of complementing internal threads or threading formed in a socket 77 formed at vertex 53 of body 41. In this example, socket 77 is formed in and projects upwardly with respect to vertex 53 and outer surface 51 of body 41, and socket 77 is formed with internal threads or threading forming the complementing threaded element 76. To secure lower end 72 of elongate support 70 to vertex 53 of body 41, lower end 72 is registered with respect to socket 77 and is held to align its external threads or threading forming the threaded element 75 with the internal threads or threading of the complementing threaded element 76 formed in socket 77, and lower end 72 of elongate support 70 is threaded into socket 77 through rotation elongate support 70 with respect to body 41 to threadably secure the external threads or threading of the threaded element 75 formed in lower end 72 of elongate support 70 to the internal threads or threading of the complementing threaded element 76 formed in socket 77, whereupon through this rotation, which can be either clockwise or counterclockwise rotation, lower end 72 of elongate body 70 is threadably tightened securely in place with respect to vertex 53 of body 41. To detach elongate support 70 from body 41, the foregoing operation to secure elongate support 70 to body 41 need only be reversed.

With ongoing attention to FIG. 5, handle 42 is an elongate, cylindrical body, which, in this example, is hollow but may be solid if desired. Handle 42 has an upper end 80 attached to vertex 53 of body 41, and extends downwardly from vertex 53 with respect to lower surface 52 and lower end 72 of elongate support 70 through body 41 to a lower end 81 located below and away from bottom 50 of body 41. Base 43 is attached to lower end 81 of handle 42, and base 43 is positionable upon a support surface to support perch assembly 30 in a stable, upright position. Preferably, elongate support 70 is coaxial with respect to handle 42.

A fastener assembly is formed between upper end 80 of handle 42 and vertex 53 of body 41, which releasably secures upper end 80 of handle 42 to vertex 53 of body 41 thereby releasably securing handle 42 with respect to vertex 53 of body 41. The fastener assembly is formed by a threaded element 85 formed in upper end 80 of handle 42, and a complementing threaded element 86 formed in vertex 53.

In the present example, threaded element 85 formed in upper end 80 of handle 42 consists of external threads or threading formed in upper end 80 of handle 42, and complementing threaded element 86 formed in vertex 53 consists of complementing internal threads or threading formed in a socket 87 formed at vertex 53 of body 41. In this example, socket 87 is formed in interior 54 of body 41 and projects downwardly with respect to vertex 53 in interior 54 of body 41 toward bottom 50, and socket 87 is formed with internal threads or threading forming the complementing threaded element 86. To secure upper end 80 of handle 42 to vertex 53 of body 41, upper end 80 is directed into interior 54 of body 41 though bottom 50 of body 41 and is registered with respect to socket 87 and is held to align its external threads or threading forming the threaded element 85 with the internal threads or threading of the complementing threaded element 86 formed in socket 87, and upper end 80 of handle 42 is threaded into socket 87 through rotation handle 42 with respect to body 41 to threadably secure the external threads or threading of the threaded element 85 formed in upper end 80 of handle 42 to the internal threads or threading of the complementing threaded element 86 formed in socket 87, whereupon through this rotation, which can be either clockwise or counterclockwise rotation, upper end 80 of handle 42 is threadably tightened securely in place with respect to vertex 53 of body 41. To detach handle 42 from body 41, the foregoing operation to secure handle 42 to body 41 need only be reversed. As previously mentioned, elongate support 70 is coaxial with respect to handle 42. As such, socket 77 is coaxial with respect to socket 87.

With handle 42 so attached to vertex 53 of body 41, handle 42 extends downwardly from vertex 53 with respect to lower surface 52 and lower end 72 of elongate support 70 through body 41 to a lower end 81 located below and away from bottom 50 of body 41, as previously explained. A fastener assembly is formed between lower end 81 of handle 42 and base 43, which releasably secures lower end 81 of handle 42 to base 43 thereby releasably securing handle 42 with respect to base 43. The fastener assembly between handle 42 and base 43 is formed by a threaded element 95 formed in lower end 81 of handle 42, and a complementing threaded element 86 formed in base 43.

Base 43 includes a broad, flat base plate 100 having opposed, planar, parallel upper and lower faces 101 and 102, a perimeter edge 103. Base 43 also includes a continuous sidewall 104. Continuous sidewall 104 has a continuous lower edge 105 affixed to upper face 101 of base plate 100 proximate to perimeter edge 103, and extends upwardly from base plate 100 and narrows to a continuous upper edge 106 that encircles an opening 107 into interior 108 of base 43 bound by upper face 101 of base plate 100 and continuous sidewall 104. Opening 107 opposes upper face 101 of base plate 100.

In the present example, threaded element 95 formed in lower end 81 of handle 42 consists of external threads or threading formed in lower end 81 of handle 42, and complementing threaded element 96 formed in base 43 consists of complementing internal threads or threading formed in a socket 97 formed in upper face 101 of base plate 100. Socket 97 extends upwardly and away from upper face 101 of base plate 100 toward opening 107. Opening 107 opposes and is coaxial with respect to socket 97. To secure lower end 81 of handle 42 to base 43, lower end 81 is directed into the interior 108 of base 43 through opening 107 and is registered with respect to socket 97 and is held to align its external threads or threading forming the threaded element 95 with the internal threads or threading of the complementing threaded element 96 formed in socket 97, and lower end 81 of handle 42 is threaded into socket 97 through rotation handle 42 with respect to base 43 to threadably secure the external threads or threading of the threaded element 95 formed in lower end 81 of handle 42 to the internal threads or threading of the complementing threaded element 96 formed in socket 97, whereupon through this rotation, which can be either clockwise or counterclockwise rotation, lower end 81 of handle 42 is threadably tightened securely in place with respect to base 43. To detach handle 42 from base 43, the foregoing operation to secure handle 42 to base 43 need only be reversed. As previously mentioned, elongate support 70 is coaxial with respect to handle 42. As such, socket 97 is coaxial with respect to socket 87, which is, in turn, coaxial with respect to socket 77.

Referencing FIGS. 1-5 in relevant part, perch assembly is shown assembled, in which there is elongate support 70 including upper end 71 and opposed lower end 72, perch 40 for a bird formed upper end 71 of elongate support 70, and substantially cone-shaped body 41 including open bottom 50 and opposed upper and lower surfaces 51 and 52 that narrow from bottom 50 to vertex 53 opposing bottom 50. The threaded and complementing threaded elements 75 and 76 forming the fastener assembly between lower end 72 of elongate support 70 and vertex 53 of body 41 are threaded together releasably securing lower end 72 of elongate support 70 to vertex 53 of body 41, and elongate support extends upwardly from vertex 53 with respect to upper surface 51 to upper end 71 formed with perch 40, which is horizontal. Upper surface 51 and annular waste-collection trough 56 are situated below or otherwise underneath perch 40, and upper surface 51 extends downwardly and circumferentially away from perch 40 to trough 56, which projects or otherwise extends circumferentially outwardly or otherwise outboard with respect to opposed ends 40A and 40B of perch 40, in accordance with the principle of the invention. More particularly, the outer diameter of D of trough 56 denoted in FIG. 5 is greater than the overall length of perch 40 from end 40A to end 40B, and extends outward with respect to ends 40A and 40B. The threaded and complementing threaded elements 85 and 86 forming the fastener assembly between upper end 80 of handle 42 and vertex 53 of body 41 are threaded together releasably securing upper end 80 of handle 42 to vertex 53 of body 41. Handle 42 extends downwardly from vertex through interior 54 with respect to lower surface 52 and lower end 72 of elongate support 70 to lower end 81 of handle 42, which is located below and away from bottom 50 of body 41, and base 43 is attached to lower end 81 of handle 42 with the fastener assembly formed between lower end 81 of handle 42 and base 43.

As seen in FIG. 1, lower face 102 of base 43 is positionable upon a support surface, such as support surface 31, to support perch assembly 30 in a stable, upright position as clearly illustrated. In this positioning of perch assembly 30, perch 40 is free to receive a perching bird, such as bird 32. Should bird 32 defecate while perched or otherwise standing on perch 40, the defecation will fall downwardly onto upper surface 51 of body 41, and defecation will also fall and be collected and contained or held in trough 56. Because upper surface 51 projects circumferentially downward to trough 56 and trough 56 and continuous edge 50A formed in bottom 50 project or otherwise extends circumferentially outwardly or otherwise outboard with respect to opposed ends 40A and 40B of perch 40, upper surface 51 and/or trough will collect crumbs and defecation produced by a bird perched on perch 40 regardless of where the bird is perched on perch 40, in accordance with the principle of the invention.

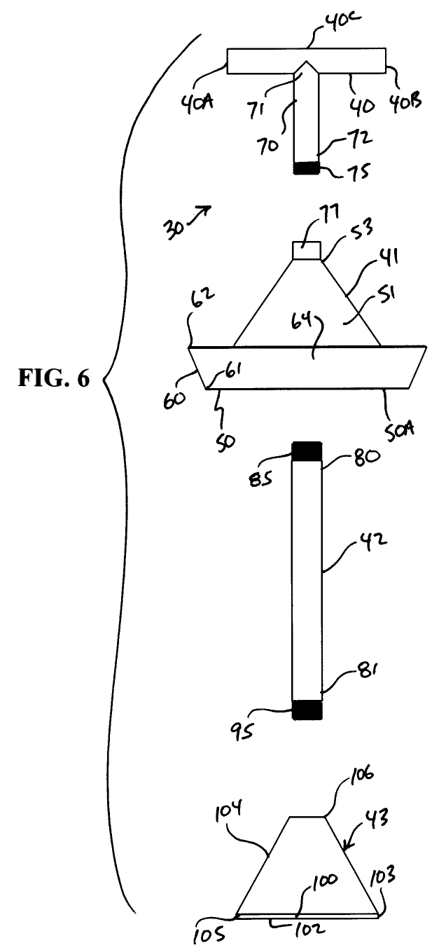

Perch assembly 30 is useful by setting it on a support surface as shown in FIG. 1. Perch assembly 30 is further useful when held by hand, and may be taken up by hand to support a bird perched on perch 40 and is structured to so be used. In this example, a user may take up handle 42 by hand, such between bottom 50 of body 41 and base 43, and carry perch assembly 30 about while held by hand with a bird perched on perch 40. FIG. 6A shows handle 42 taken up by hand holding perch assembly 30 upright with bird 32 perched on perch 40, and in FIG. 6A perch assembly 30 is shown without base 43 (not shown in FIG. 6A) attached. Base 43 need not be attached to lower end of handle 42 when perch assembly 30 is used and held by hand as in FIG. 6A. Because upper surface 51 and trough 56 underlying perch 40 will collect defecation produced by the bird perched on perch 40, defecation produced by the bird standing on perch 40 will not fall onto the user's hand holding handle 42, such that body 41 functions as a shield shielding a user's hand holding handle 42 from defecation produced by a bird standing on perch 40 and from being bitten by a bird standing on perch 40, in accordance with the principle of the invention. Body 41 also shields the user's hand from being bitten by a bird perched on perch 40.

FIG. 6 is an exploded side elevation view of perch assembly 30 illustrating handle 42 detached from body 41 and base 43, and elongate support 70 carrying perch 40 detached from body 41. The releasability between these parts of perch assembly 30 allows them to be separated as needed for cleaning or replacement. It is to be understood that base 43 need not be attached to lower end 81 of handle 42 when perch assembly 30 is held by hand in supporting a bird perched on perch 40. Although perch assembly 30 is formed with one perch 40, it can be formed with two or more perches if desired for accommodating a plurality of perching birds.

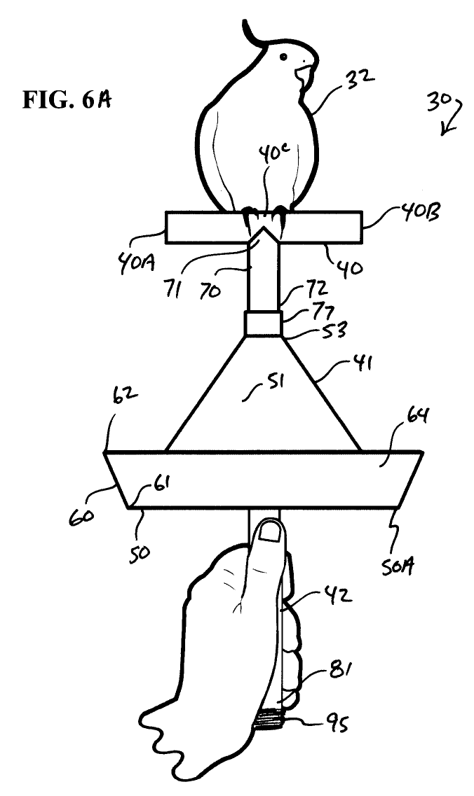

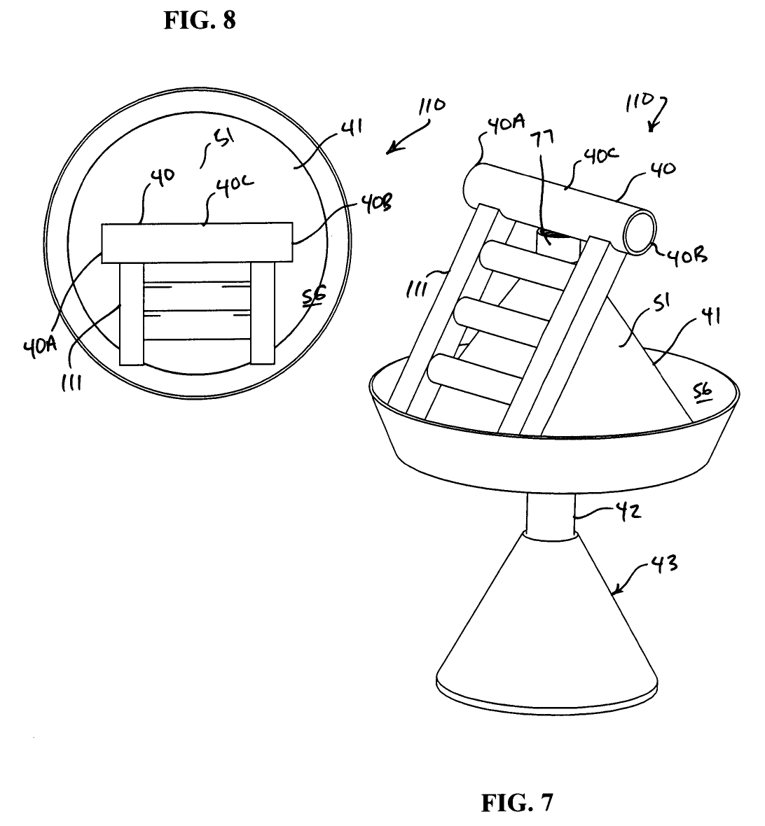

Reference is now made to FIG. 7, which is a perspective view of an alternate embodiment of a perch assembly 110 for a bird, which is constructed and arranged in accordance with the principle of the invention. In common with perch assembly 30, perch assembly 110 shares handle 42 attached to body 41 and base 43, and perch 40. In this example, and with additional reference to FIG. 8, which is a top plan view of perch assembly 110, perch 40 has the same dimension and relative positioning with respect to body 41 as explained in connection with perch assembly 30, but is formed directly atop socket 77 and is formed in the top of a ladder 111 extending along upper surface 51 of body 41 between perch 40 and trough 56. In this example, midsection 40C is affixed to socket 77, such as with adhesive or welding, and the bottom of ladder 111 is affixed to body 41 at trough 56, such as with adhesive or welding. The provision of ladder 111 allows a bird to walk up and down ladder 111 with respect to body 41 for exercise, entertainment, and reward.

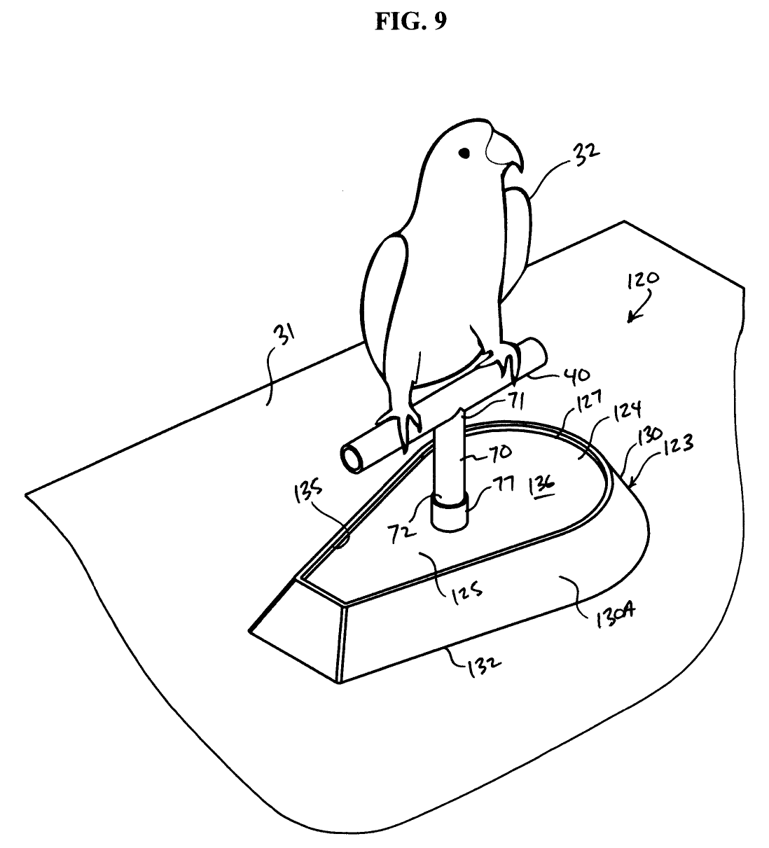

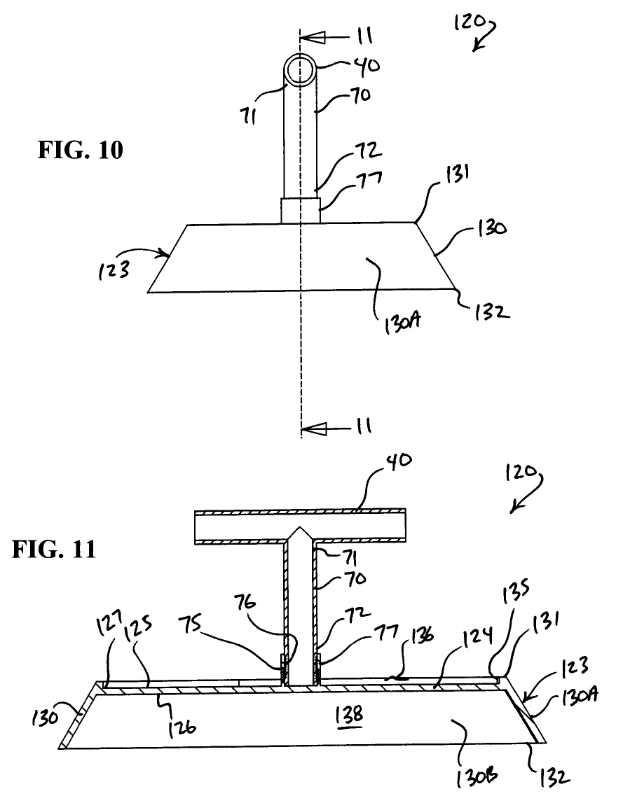

Looking now to FIG. 9 there is seen a perspective view of another alternate embodiment of a perch assembly 120 for a bird, which is constructed and arranged in accordance with the principle of the invention and is shown as it would appear with a bird perched thereon, namely, bird 32. In common with perch assembly 30 discussed above, perch assembly 120 shares elongate support 70 with upper end 71 formed with perch 40 onto which bird 32 is perched as shown in FIG. 9, and lower end 72 releasably secured to socket 77 with the fastening assembly consisting of threaded element 75 and complementing threaded element 76 denoted in FIG. 11, which is a sectional view taken along line 11-11 of FIG. 10, which is a side elevation view of perch assembly 120.

In this example, perch assembly 120 is formed with a base 123 that includes a base plate 124 having, as best seen in FIG. 11, opposed upper and lower surfaces 125 and 126 and a perimeter edge 127. In this embodiment, socket 77 is formed in, and extends upwardly with respect to, upper surface 125 of base plate 124 at a substantially central location. Perimeter edge 127 of base plate 124 of base 123 formed with an attached continuous sidewall 130 that includes a continuous upper edge 131 extending somewhat upwardly with respect to upper surface 125 of base plate 124, and which extends downwardly and somewhat outwardly from perimeter edge 127 of base plate 124 to an opposed continuous lower edge 131, which may be set onto support surface 31 as shown in FIG. 9 to allow base 123 to support perch assembly 120 in a stable, upright position with respect to support surface 31 as shown in FIG. 9 to allow a bird, such as bird 32, to perch comfortably on perch 40. As shown in FIG. 11, continuous sidewall 130 has opposed outer and inner surfaces 130A and 130b. Inner surface 130B cooperates with lower surface 126 of base plate 124 to form an interior or receiving area 138 of base 123.

In perch assembly 120, upper surface 125 of base plate 124 is situated below perch 40. Because continuous sidewall 130 projects somewhat upwardly with respect to upper surface 125 of base plate 124 and perimeter edge 127 of base plate 124 to continuous upper edge 131, continuous sidewall 130 forms a continuous flange 135 that extends from upper surface 125 of base plate 124 at perimeter edge 127 to continuous upper edge 131 of continuous sidewall 130, and that encircles perimeter edge 127. This continuous flange 135 cooperates with upper surface 125 of base plate 124 to form a collection receptacle or trough 136 opposing and underlying perch 40 to receive, collect, and contain defecation produced by a bird perched on perch 40.

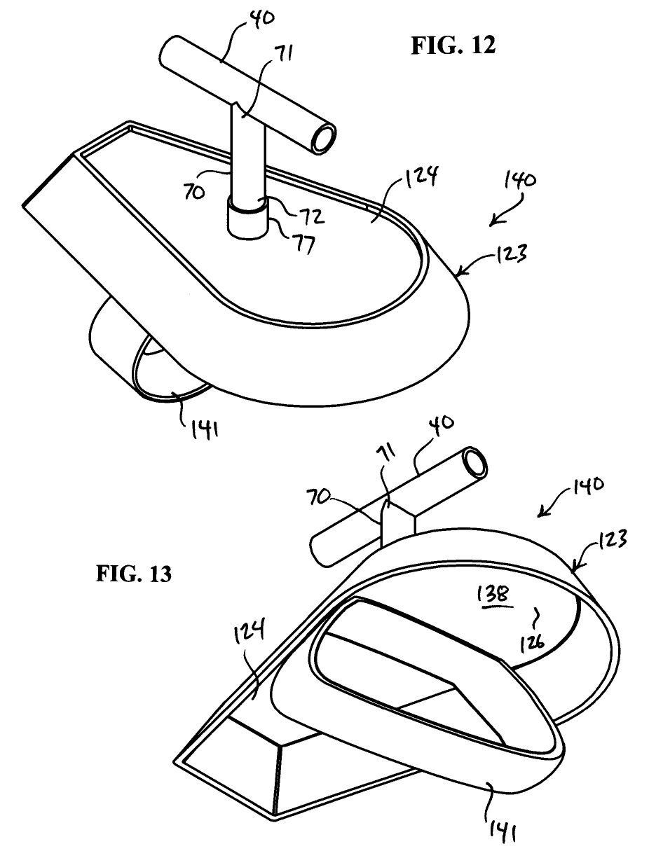

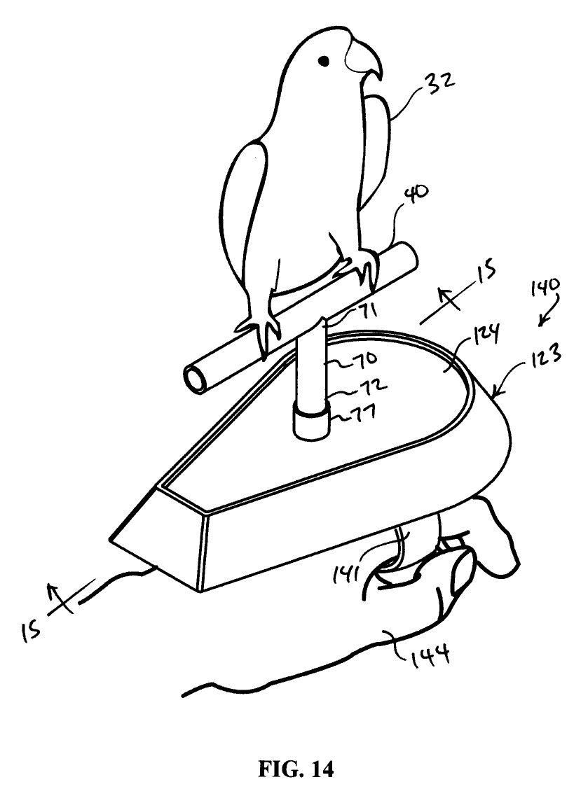

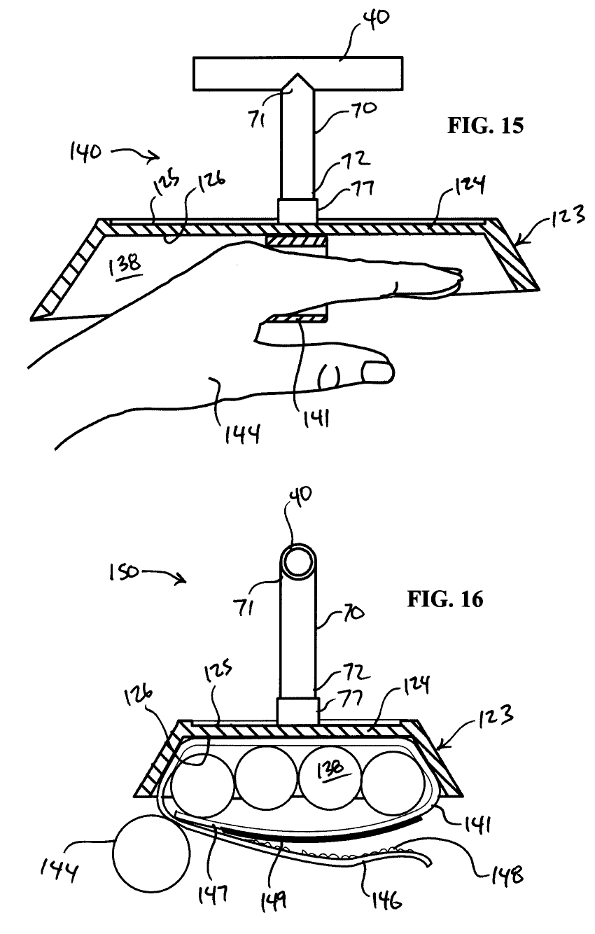

FIGS. 12-15 illustrate yet another alternate embodiment of a perch assembly 140 for a bird, which perch assembly 140 is constructed and arranged in accordance with the principle of the invention. Referring to FIGS. 12-15 in relevant part, perch assembly 120 is common perch assembly 140 in that perch assembly 120 shares elongate support 70 with upper end 71 formed with perch 40, and lower end 72 releasably secured to socket 77 formed in base 123. In this example, base 123 is formed with an attached strap 141, which is used to secure perch assembly 140 to a human hand. Looking specifically to FIG. 13, strap 141, which is formed of leather, vinyl, or other similarly pliant, flexible material or combination of materials, is formed in receiving area or interior 138 of base 123, and is secured to lower surface 126 of base plate 124, such as with adhesive, or with one or more fasteners, such as one or more rivets, screws, or the like. Strap 141 can be secured in place in other ways, such as through openings or slots formed in base 123. In this embodiment, receiving area or interior 138 is sized to receive a human hand 144 therein as shown in FIG. 15, which hand 144 is passed into and through strap 141 in order to attach perch assembly 140 to hand 144 to protect the hand from defecation and from being bitten by a bird perched on perch 40, and to allow a user to reliably and stably hold perch assembly 140 by hand in a stable, upright position while a bird is perched on perch 40, such as bird 32 illustrated in FIG. 14. As illustrated in FIGS. 14 and 15, base 123 is located on top of the back of hand 144 and hand 144, with the exception of the thumb, is extending into and through strap 141, which encircles and embraces hand 144 and thereby firmly attaching perch assembly 140 to hand 144. Strap 141 in perch assembly 140 is unsevered in perch assembly 140.

FIG. 16 is a vertical sectional view of yet still a further alternate embodiment of a perch assembly 150 constructed and arranged in accordance with the invention. In common with perch assembly 140, perch assembly 150 shares elongate support 70 with upper end 71 formed with perch 40, and lower end 72 releasably secured to socket 77 formed in base 123, and strap 141. In this embodiment, strap 141 is severed forming opposed ends 146 and 147. A fastening assembly is formed in ends 146 and 147 allowing ends 146 and 147 to be disconnected to open strap 141, and connected to close strap 141 about human hand 144, which is represented by a series of circles being generally indicative of the fingers of human hand 144, whereby four of the fingers are indicated encircled by strap 141. This allows strap 141 to be adjusted as needed in order to fit human hands of varying size. The fastening assembly formed in ends 146 and 147 of strap includes an engagement element 148 carried by end 146 of strap 141 and a detachably engagable complementing engagement element 149 carried by end 147 of strap 141. In this example, engagement element 148 is a loop element of a hook and loop fastener, and complementing engagement element 149 is the complementing hook element of the hook and loop fastener. In other examples, other forms of fastening assemblies can be formed in ends 146 and 147 of strap 141, such as one or more mutual snap fasteners, button fasteners, buckle fasteners, or other like or similar fastener or fastener assembly suitable to connect the opposed ends of a strap.

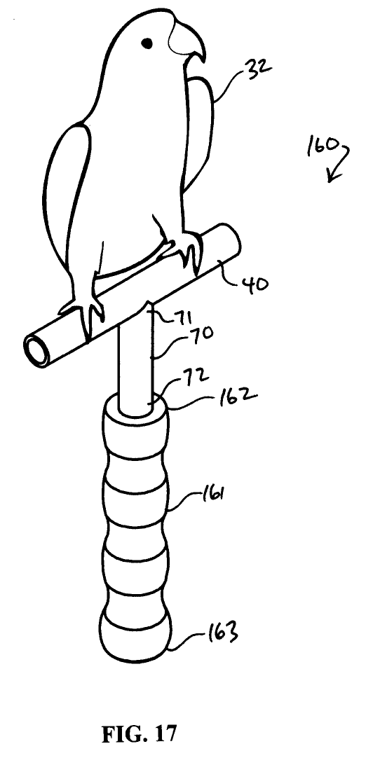

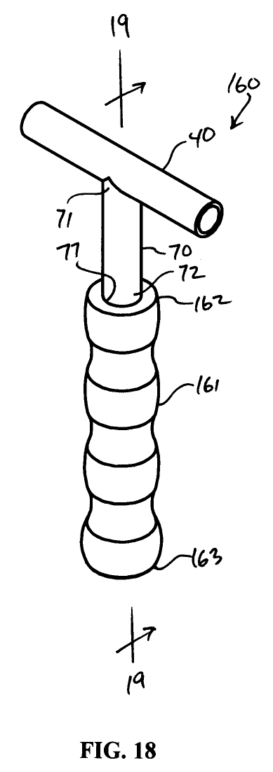

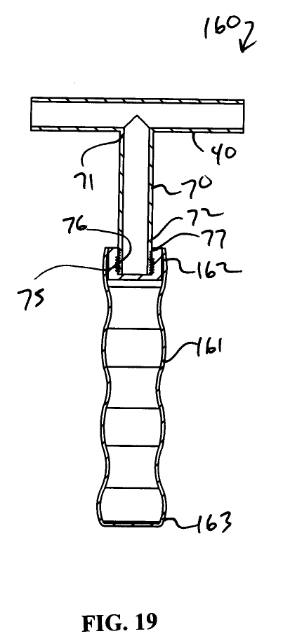

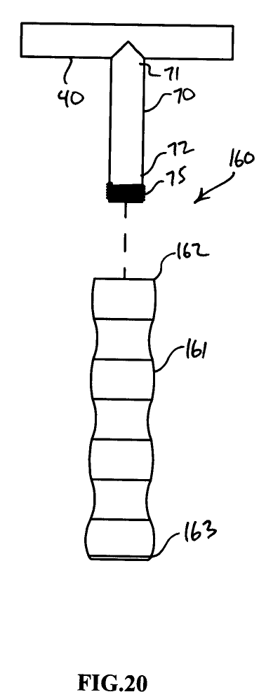

Reference is now made to FIGS. 17-20, which show still another alternate embodiment of a perch assembly 160 for a bird constructed and arranged in accordance with the principle of the invention. In common with perch assembly 30, perch assembly 160 shares elongate support 70 with upper end 71 formed with perch 40, and lower end 72 releasably secured to socket 77 with the fastening assembly shown in FIG. 19 consisting of threaded element 75 and complementing threaded element 76. In this embodiment, perch assembly 160 incorporates an elongate handle 161 having opposed upper and lower ends 162 and 163. Socket 77 is formed in upper end 162 of handle 161. With lower end 72 of elongate support 70 secured to socket 77 formed in upper end 162 of handle 161 with the fastening assembly formed in socket 77 and lower end 72 of elongate support 70, handle 161 can be easily taken up by hand and held in a stable, upright position to support by hand a bird perched on perch 40, such as bird 32 perched on perch 40 of perch assembly 160 illustrated in FIG. 17. Elongate support 70 is sufficiently long to reduce the threat of being bitten on the hand while holding handle 161. FIG. 20 is an exploded, side elevation view of perch assembly 160 shown with elongate support 70 carrying perch 40 detached with respect to handle 161. Handle 161 is preferably formed with intentions to accommodate the fingers and contours of a typical human hand, and is formed with a grip, such as a rubber or rubber-like grip, which is a soft and comfortable to grip.

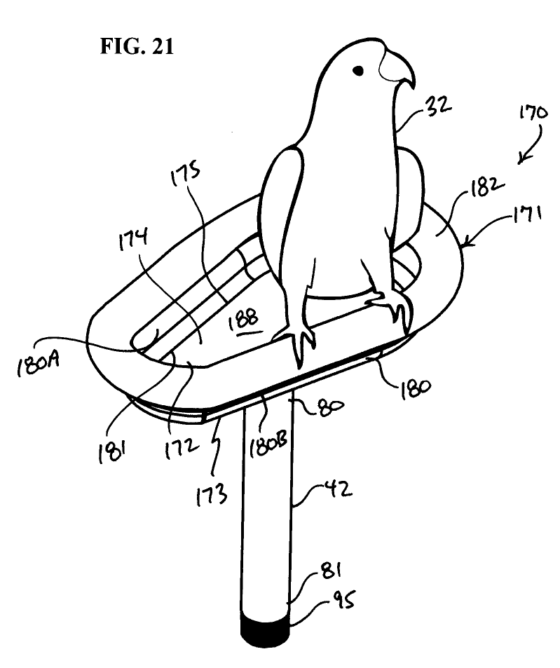

To close this specification, reference is now made to FIGS. 21-23 illustrating yet another alternate embodiment of a perch assembly 170 for a bird constructed and arranged in accordance with the principle of the invention and which is shown as it would appear with a bird perched thereon in FIG. 21, namely, bird 32. In common with perch assembly 30, perch assembly 170 shares handle 42 having lower end 81 and opposed upper end 80 releasably secured to socket 87 (shown only in FIG. 23) with the fastening assembly consisting of the threaded and complementing threaded elements (not shown).

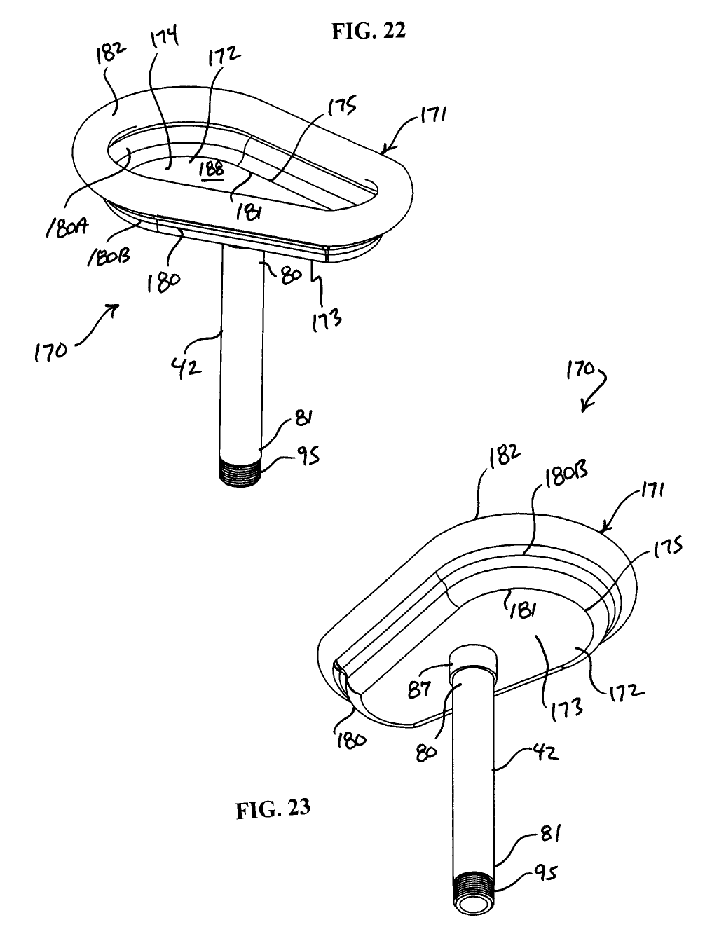

In this example, perch assembly 170 is formed with a perch structure 171 that includes a floor or base plate 172 having a lower surface 173 shown in FIG. 23, an opposed upper surface 174 shown in FIGS. 21 and 22, and a perimeter edge 175. In this embodiment, socket 87 is formed in, and extends downwardly with respect to, lower surface 173 of base plate 172 at a substantially central location. Perimeter edge 175 of base plate 172 is formed with an attached, upstanding continuous sidewall 180 that includes a continuous lower edge 181 affixed to upper surface 174 of base plate 172 at perimeter edge 175 and which extends upwardly from perimeter edge 175 to an opposed continuous upper rim 182, which is rounded and sized to form a comfortable perch upon which a bird may stand upon, such as bird 32 in FIG. 21 shown standing on rim 182. As shown in FIGS. 21 and 22, continuous sidewall 180 has opposed inner and outer surfaces 180A and 180b. Inner surface 180A cooperates with upper surface 174 of base plate 172 to form an broad interior or receiving area 188 of perch structure 171 within which a bird may sit and rest as if nesting in a nest. In fact, perch structure 171 is exemplary of a nest, and is particularly useful in holding birds that suffer from physical challenges or that convalescing from sustained injuries that make standing on rim 182 difficult or impossible.

Those having ordinary skill in the art will readily exemplary perch assemblies are disclosed. The various perch assemblies are easy and inexpensive to construct, are easily assembled, are easily disassembled for part cleaning or replacement, are designed and structured to be taken up by hand and held, are useful in that they provide perches upon which a bird may perch, and provide protection for the user. Because the various perch assemblies incorporate fastener assemblies to releasably attach together the various parts thereof, the perch assemblies are modular in nature, are readily able to be disassembled for storage or transport and for part cleaning and replacement, and are readily able to be assembled for immediate use. In accordance with the spirit and scope of the invention, it is to be understood that the positioning of the elements and respective complementing elements of the fastener assemblies utilized to releasably attach the various parts of the various perch assemblies can be reversed if so desired without departing from the invention. And again, it is to be understood that the perches of the various perch assemblies can be configured in any size and shape suitable to permit birds to perch comfortably thereon consistent with the teachings of the various embodiments.

The invention has been described above with reference to preferred embodiments. However, those skilled in the art will recognize that changes and modifications may be made to the embodiments without departing from the nature and scope of the invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A perch assembly for a bird, comprising:
a substantially cone-shaped body including an open bottom and opposed upper and lower surfaces that narrow from the open bottom to an opposed vertex; and
a perch for a bird carried by the substantially cone-shaped body, the perch formed proximate to the vertex.

2. The perch assembly according to claim 1, further comprising an annular waste-collection trough formed in and encircling the bottom of the substantially cone-shaped body.

3. The perch assembly according to claim 2, further comprising:
a handle having an upper end and an opposed lower end;
a first fastener assembly releasably securing the upper end of the handle to the vertex of the substantially cone-shaped body including a first element thereof carried by the upper end of the handle and a first complementing element thereof carried by the vertex; and
the handle extends downwardly from the vertex with respect to the lower surface of the substantially cone-shaped body to the lower end of the handle located below and away from the bottom of the substantially cone-shaped body.

4. The perch assembly according to claim 3, further comprising a base attached to the lower end of the handle, the base positionable upon a support surface to support the perch assembly in a stable, upright position.

5. The perch assembly according to claim 4, further comprising a second fastener assembly releasably securing the lower end of the handle to the base including a second element thereof carried by the lower end of the handle and a second complementing element thereof carried by the base.

6. The perch assembly according to claim 5, wherein the first element of the first fastener assembly comprises a first threaded engagement element, and the first complementing element of the first fastener assembly comprises a first complementing threaded engagement element threadably engaging the first threaded engagement element.

7. The perch assembly according to claim 6, wherein the second element of the second fastener assembly comprises a second threaded engagement element, and the second complementing element of the second fastener assembly comprises a second complementing threaded engagement element threadably engaging the second threaded engagement element.

8. The perch assembly according to claim 1, further comprising a ladder opposing the upper surface of the substantially cone-shaped body extending between the trough and the perch.

9. A perch assembly for a bird, comprising:
a substantially cone-shaped body including an open bottom and opposed upper and lower surfaces that narrow from the open bottom to an opposed vertex;
an elongate support including an upper end and an opposed lower end attached to the vertex of the substantially cone-shaped body;
a perch for a bird formed in the upper end of the elongate support; and
the elongate support extends upwardly from the vertex with respect to the upper surface to the upper end formed with the perch.

10. The perch assembly according to claim 9, further comprising an annular waste-collection trough formed in and encircling the bottom of the substantially cone-shaped body.

11. The perch assembly according to claim 10, further comprising a handle having an upper end attached to the vertex of the substantially cone-shaped body and extends downwardly from the vertex with respect to the lower surface and the lower end of the elongate support to a lower end located below and away from the bottom of the substantially cone-shaped body.

12. The perch assembly according to claim 11, further comprising a base attached to the lower end of the handle, the base positionable upon a support surface to support the perch assembly in a stable, upright position.

13. A perch assembly for a bird, comprising:
an elongate support including an upper end and an opposed lower end;
a perch for a bird formed in the upper end of the elongate support;
a substantially cone-shaped body including an open bottom and opposed upper and lower surfaces that narrow from the open bottom to an opposed vertex;
a first fastener assembly releasably securing the lower end of the elongate support to the vertex of the substantially cone-shaped body including a first element thereof carried by the lower end of the elongate body and a first complementing element thereof carried by the vertex; and
the elongate support extends upwardly from the vertex with respect to the upper surface to the upper end formed with the perch.

14. The perch assembly according to claim 13, further comprising an annular waste-collection trough formed in and encircling the bottom of the substantially cone-shaped body.

15. The perch assembly according to claim 14, further comprising:
a handle having an upper end and an opposed lower end;
a second fastener assembly releasably securing the upper end of the handle to the vertex of the substantially cone-shaped body including a second element thereof carried by the upper end of the handle and a second complementing element thereof carried by the vertex; and
the handle extends downwardly from the vertex with respect to the lower surface and the lower end of the elongate support to the lower end of the handle located below and away from the bottom of the substantially cone-shaped body.

16. The perch assembly according to claim 15, further comprising a base attached to the lower end of the handle, the base positionable upon a support surface to support the perch assembly in a stable, upright position.

17. The perch assembly according to claim 16, further comprising a third fastener assembly releasably securing the lower end of the handle to the base including a third element thereof carried by the lower end of the handle and a third complementing element thereof carried by the base.

18. The perch assembly according to claim 17, wherein the first element of the first fastener assembly comprises a first threaded engagement element, and the first complementing element of the first fastener assembly comprises a first complementing threaded engagement element threadably engaging the first threaded engagement element.

19. The perch assembly according to claim 18, wherein the second element of the second fastener assembly comprises a second threaded engagement element, and the second complementing element of the second fastener assembly comprises a second complementing threaded engagement element threadably engaging the second threaded engagement element.

20. The perch assembly according to claim 19, wherein the third element of the third fastener assembly comprises a third threaded engagement element, and the third complementing element of the third fastener assembly comprises a third complementing threaded engagement element threadably engaging the third threaded engagement element.
